(19) United States
(12) Patent Application Publication
(10) Pub. No.: US 2006/0157057 A1
(43) Pub. Date: Jul. 20, 2006

(54) Apparatus

(76) Inventor: Maria Palmquist, Djursholm (SE)

Correspondence Address: Ralph A. Dowell of DOWELL & DOWELL P.C., 2111 Eisenhower Ave, Suite 406, Alexandria, VA, 22314, US

(21) Appl. No.: 10/536,748

(22) PCT Filed: Dec. 2, 2003
(86) PCT No.: PCT/SE03/01868

§ 371 Date: Feb. 7, 2006

(30) Foreign Application Priority Data
Dec. 2, 2002 (SE) 0203561-6

(51) Int. Cl. A62B 17/04; A62B 18/08

(52) U.S. Cl. 128/201.22; 128/201.26

(57) ABSTRACT

The present invention relates to an apparatus for securing inhalation of substantially smokeless air from a smoky room, which apparatus comprises a protection (2) that is arranged over at least nose and mouth at face (4) of a user, to which protection a tightly arranged tubular body (6) is connected, a nozzle is arranged at the end (8) of the tubular body at the inside of the protection adapted to placed against the mouth of the user, which communicates with an air inlet opening (10) in the other end of the tubular body and the tubular body forms a length (l) in elongated condition that at least extends to adjacent ground level, that the tubular body (6), that is formed of flexible material, is compactable and/or expandable and together with the protection (2) in a folded condition forms a package that has its substantial propagation in one plane (P) and requires little space.

### TECHNICAL FIELD

The present invention relates to an apparatus for securing inhalation of substantially smokeless air from a smoky room.

### BACKGROUND

People that are killed in connection to fires dies in most cases by asphyxiation and choking, not by the fire itself. When a room starts to get filled by smoke from a fire, the flue gases are firstly gathered against the ceiling. The longer time that passes, the more smoke fills the room from the ceiling and down against the floor. Hence, the smokeless space over the floor decreases successively and after a certain period the entire room is substantially filled with smoke. While a relatively smokeless airlayer exists in the room a person might get along awhile by getting air from the air-filled layer. However, when the smoke has filled a considerable part of the room the smokeless air can only be inhaled by crouching down, crawling or even worm one's way along the floor. The ability to rapidly get oneself out from a smoke-filled room, such as a building of considerable size, is thereby limited.

Protective masks, such as gas masks, of various kinds are previously known. A frequently occurring protective mask is a tight face mask of rubber material to which a valve with a filter, arranged at the valve, is connected. This type of protective mask is certainly effective against flue gas and can be adapted also for other kinds of gases, but requires use of advanced and costly filters. The endurance is limited depending on way of storage. The protective mask with the filter holder and the valve is also space requiring. Due to save space, criteria for storage and cost, such protective masks are usually not set out in public and official rooms, where such protective masks should exist available, in event of fire, for immediate use and rapid evacuation of distressed persons.

By GB-A-2134393 is previously known an apparatus adapted for inhalation of air in e.g. smoke-filled rooms. The apparatus comprises a face mask and a tube connected thereto through which air can be inhaled from the area at ground level. The tube is formed of PVC and provided with ribs adapted to provide the tube additional strength. The apparatus is for example adapted to be arranged along the side of a hospital bed for availability.

### DESCRIPTION OF THE INVENTION

An object of the present invention is to provide a protective mask that eliminates the drawbacks that are associated with known protective masks. Yet an object is to provide a simplified protective mask that is small and adaptable in packed size and that can be manufactured to a low cost.

This object is achieved by an apparatus for securing inhalation of substantially smokeless air from a smoky room according to the present invention as defined in claim 1, which apparatus comprises a protection that is arranged over at least nose and mouth at face of a user, to which protection a tightly arranged tubular body is connected, a nozzle is arranged at the end of the tubular body, at the inside of the protection adapted to placed against the mouth of the user, which communicates with an air inlet opening in the other end of the tubular body and the tubular body forms a length in elongated condition that at least extends to adjacent ground level, that the tubular body, that is formed of flexible material, is compactable and/or expandable and together with the protection in a folded condition forms a package that has its substantial propagation in one plane and requires little space.

An advantage by this solution according to the present invention is that the apparatus in prepacked, compacted condition state occupy insignificant space, and is inexpensive to produce, which makes it suitable as a disposable product, and also simple to handle, which all in all facilitate that it can be brought along in all situations and set out easily available in all accommodations for rapid access when needed. The apparatus facilitates that the user can move quickly and upright during simultaneous inhalation of smokeless air.

It is important in accordance with the present invention that all included parts of the apparatus are designed such that the apparatus in prepacked condition, thus when it not is in use, can make such a space saving unit as far as possible. In that respect, the tubular body should comprise components that facilitate that it can be expanded to desired length when the apparatus shall be used and can be compressed to a compact, small, space saving unit with insignificant propagation in storage, such as in a package. By expandability is meant that the apparatus can be pulled out, unfolded, drawn out or the similar. By compression or compaction is meant that the apparatus can be folded, wrapped, compressed, drawn in or the similar. For this reason, according to an embodiment of the present invention, the tubular body may be formed of a thin film or the similar, such as a plastic film, that forms a defined air channel. The formed air channel of the film surrounds a helical strip arranged in the air channel, alternatively a helical thread or the similar, that in elongated state substantially corresponds to the length of the air channel formed by the film. According to an alternative embodiment the tubular body can be formed of a thin-walled, elastic and flexible material, which is provided with folds, suitably evenly spread along its longitudinal extension. In that respect, the tubular body can be compared with a bellows-like structure which leads to that it can be compressed, compacted, to a compact little and substantially flat space saving unit with insignificant extension in length. Suitably the extension in length in compacted state is less than half the length of the tubular body in maximal pulled out condition. In pulled out, expanded condition the tubular body can have a longitudinal extension that at least corresponds to the distance from a users mouth down to adjacent ground level. According to yet an alternative embodiment the tubular body may comprise a number of tube segments that are telescopically displaceable in each other. In that respect, the tubular body can in compressed state form a length that correspond to the length of one of the tube segments. In pulled-out, expanded state the tube segments can be displaced in each other such that the connected tube sections together forms a tubular body with a considerable longitudinal extension, in accordance with desired length at use of the apparatus of the present invention.

In order to facilitate that the apparatus according to the present invention forms such a space saving unit as far as possible, the protection that is adapted to be arranged at the users face, which suitably can be a hood of e.g. a thin plastic film or the similar that is passed over the head of the user, should also be of a thin-walled, flexible material which facilitates that the protection can be compacted to a dense space saving unit with insignificant propagation of space. Also other included components of the apparatus, such as for example a possible included valve, should be compact and of space saving size.

Additional features according to embodiments of the invention is evident from the claims, and also in the following from the description of the embodiments.

### DESCRIPTION OF DRAWINGS

The present invention will now be described more in detail in embodiments, with reference to accompanying drawings, without restricting the interpretation of the invention thereto, where:

FIG. 1 shows in a preliminary outline an apparatus according to an embodiment of the present invention, applied on a user and ready for use,

FIG. 2A shows schematically the apparatus according to FIG. 1 in a compacted state,

FIG. 2B shows the apparatus according to FIG. 1 in a somewhat pulled out state,

FIG. 2C illustrates the apparatus according to FIG. 1 compacted for packaging,

FIG. 3A shows schematically an alternative embodiment of a tubular body in a folded condition, and

FIG. 3B shows the tubular body according to FIG. 3A in a drawn out state.

### DETAILED DESCRIPTION OF EMBODIMENTS

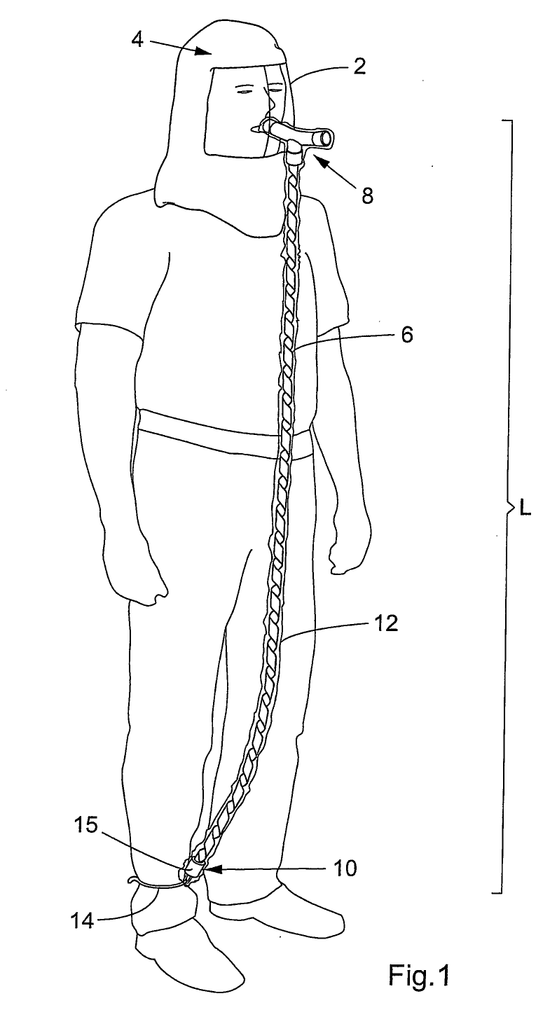

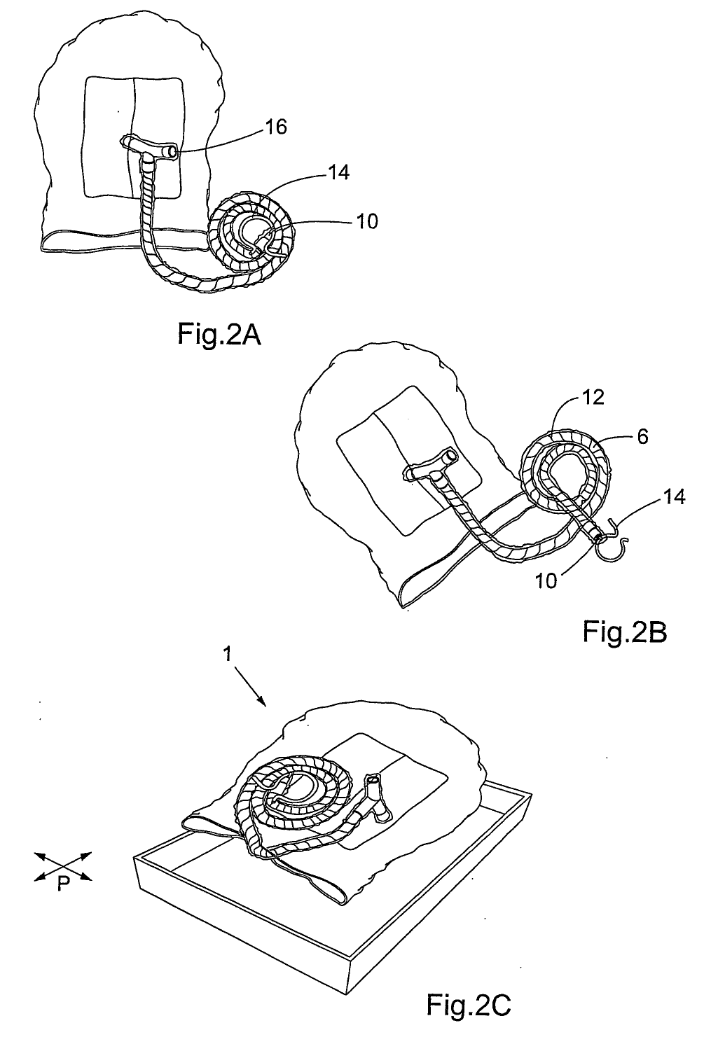

A preliminary outline of an apparatus according to an embodiment of the present invention, applied on a user and ready for use is shown in FIG. 1 and 2A-2C. The apparatus 1 comprises a protection 2 that is arranged over a face 4 of the user. The protection 2 that is shown in FIG. 1 is of a transparent, flexible plastic material, that covers the whole head, but the protection may of course be of other shape and material. The protection can preferably be of a material such as plastic, rubber or the like that withstands high temperatures over 150° C., most preferably over 300° C., which withstand hot flue gas, sparks and glow. The protection shall at least be in the shape of a so called semi-mask, i.e. that covers mouth and nose, but preferably it is at least a complete mask, e.g. that covers the whole face 4 such that also the eyes are protected from the smoke or a protection 2 that covers the whole head. Most preferably the protection 2 is a bag-like hood that covers the whole head such as shown in FIG. 1. A tubular body 6 is arranged to the protection 2 that is tightly connected such that no leakage may occur in the seam between the tubular body 6 and the protection 2. In the end 8 of the tubular body 6, at the inside of the protection, adapted to be placed to the mouth of the user, a valve 5 is arranged with a nozzle part 9. The valve communicates with an air inlet opening 10 in the other end of the tubular body. The valve 5 is of “non return valve” type, which operates such that inhaled air passes through air inlet opening 10 through the tubular body 6, and through the nozzle part 9 forward to the user. Exhaled air passes through the nozzle part and is prevented by a non-return valve mechanism in the valve 5 from returning through the tubular body 6. Instead is exhaled air let out through a valve outlet 11 of the valve.

According to a not shown alternative embodiment may in direct connection to the nozzle, at upper side of connected tubular body, a soft, flexible pillow-like element be arranged, adapted to press against the nose and choke the nostrils of the user. Pillow-like elements should have a certain air permeability to prevent feeling of choking and it should also be capable to absorb a certain amount of moisture to prevent formation of steam on the inside of the protection.

Again, with reference to FIG. 1 and 2A-2C, the tubular body is of a flexible contractible and/or pulled-out material, such as a thin-walled film of plastic, that in compact and package state requires tiny space. In the air channel that constitutes of the inner confined surfaces of the tubular body is an elastic helical strip 12 arranged, that suitably can be pulled-out to at least twice its length in comparison to its maximal contracted state. The helical strip 12 can be formed such that it springs back, from its pulled-out position to the maximal contracted state when it is not loaded. The tubular body 6 may preferably be of a material that withstands high temperatures over 150° C., most preferably over 300° C., which withstand hot flue gas and falling glow particles. The tubular body forms in elongated condition a length L that at least extends to adjacent ground level.

The length of the tubular body 6 should be almost at least corresponding to a height of a user, but should preferably not exceed the height of a user. In that respect is intended that the length L of the tubular body, from the arrangement at the protection to its free outer end at the air inlet opening, at least has an extension that corresponds to the distance from the face 4 of the user down to adjacent ground level, in the area of a foot or lower leg of the user. The tubular body may also in maximal extended condition be longer than the height of the user, whereby the outer portion of the tubular body at the inlet opening, in case the tubular body is admitted to hang loose or be arranged at the foot or the lower leg of the user, is admitted to trail also when the user stands or moves upright. Preferably, the tubular body is however in maximal extended state of a length L that is somewhat shorter than a average height of men and women such that the inlet opening 10 is arranged on a level with the area at the lower leg of the user, when the user is upright, whereby it is avoided that litter, dust, ash and other particles occurring on the ground are sucked in. The tubular body may further comprise a fastening apparatus 14, suitably adjacent of the air inlet opening in an outer portion of the tubular body, whereby the air inlet opening of the tubular body may be arranged in connection to the lower leg or foot of the user. The outer portion may in connection to the air inlet opening be provided with a weight 15 that secures a lowest position adjacent ground level of the inlet opening 10 at use of the apparatus according to the invention. As evident from FIG. 2C, the protection and the tubular body of the apparatus is designed to form an apparatus 1 in pulled out/folded state that has its substantial propagation in one plane P, whereby the apparatus occupies little space and can be packed in a suitable way.

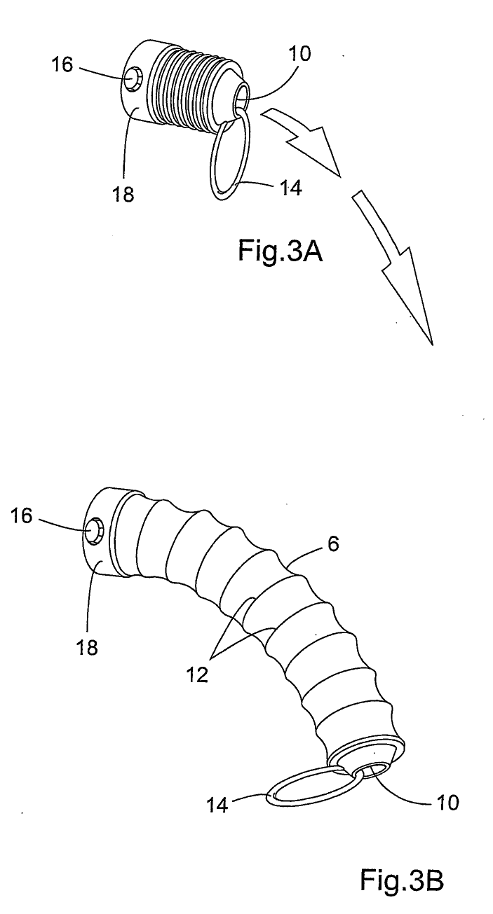

In FIG. 3A-B is shown an embodiment of a tubular body 6′ of the apparatus 1, which apparatus otherwise mainly may correspond to the apparatus 1 shown in FIG. 1 and 2A-2C, but where the tubular body 6′ constitutes of a bellows-like structure. According to this embodiment the tubular body 6′ is formed of a thin-walled material and provided with folds 13 to facilitate folding and drawing apart of the body. The tubular body is arranged to a holder 18 at the end 8 to which the protection 2 (see FIGS. 1-2, not shown in FIGS. 3A-B) is tightly connected. Schematically is also shown a valve 16, alternatively an outlet for a valve, for controlling of inhaled and exhaled air, that can be arranged in the holder 18 in connection to the nozzle. FIG. 3A shows the apparatus in an already begun extraction (see arrows) from a folded state in the holder 18. FIG. 3B shows the apparatus in extracted state. The tubular body is made of a thin-walled, elastic and flexible material and the tubular body is provided with folds 13, suitably evenly distributed along its extension. Thus, the tubular body has a bellows-like structure which admits that it can be compressed, compacted, to a compact little and substantially flat space saving unit with insignificant elongation in length. Suitably the elongation in length in compacted state is less than the diameter in transverse section. The tubular body may in elongated, expanded state have a longitudinal extension that at least corresponds to the distance from a mouth of the user down to adjacent ground level. A fastening apparatus 14′ formed of an elastic strip, for arrangement of the lower end of the tubular body at a lower leg of the user, is arranged at the air inlet opening 10.

1. Apparatus (1) for securing inhalation of substantially smokeless air from a smoky room, which apparatus comprises a protection (2) that is arranged over at least nose and mouth at face (4) of a user, to which protection a tightly arranged tubular body (6, 6′) is connected, a nozzle is arranged at the end (8) of the tubular body at the inside of the protection adapted to be placed against the mouth of the user, which communicates with an air inlet opening (10) in the other end of the tubular body and the tubular body forms a length (L) in elongated condition that at least extends to adjacent ground level, characterised in that the tubular body (6, 6′), that is formed of flexible material, is compactable and/or expandable and together with the protection (2) in a folded condition forms a package that has its substantial propagation in one plane (P) and requires little space.

2. Apparatus according to claim 1, characterised in further that the tubular body (6, 6′) at an outer portion in connection to the air inlet opening (10) is provided with a weight (15).

3. Apparatus according to claim 1, characterised in that the tubular body (6) further comprise a fastening apparatus (14, 14′), suitably adjacent of the air inlet opening (10) in an outer portion of the tubular body, whereby the air inlet opening of the tubular body may be arranged in connection to the lower leg or foot of the user.

4. Apparatus according to claim 1, characterised in that a valve (5) for control of inhaled and exhaled air is arranged in the tubular body in connection to the protection (2).

5. Apparatus according to claim 1, characterised in that the tubular body (6) may be formed of a thin film, such as a plastic film, that forms a defined air channel, that the formed air channel of the film surrounds a helical strip (12) arranged in the air channel, that in elongated state substantially corresponds to the length formed by the air channel.

6. Apparatus according to claim 1, characterised in that the tubular body (6′) is formed of a thin-walled, elastic and flexible material, which is provided with folds (13), which admits that it can be compressed, compacted, to a compact little and substantially flat space saving unit.
